(19) United States
(12) Patent Application Publication
(10) Pub. No.: US 2017/0060093 A1
(43) Pub. Date: Mar. 2, 2017

(54) DIAL AND TIMEPIECE

(71) Applicant: CASIO COMPUTER CO., LTD., Tokyo (JP)

(72) Inventors: Yusuke AWANO, Tokyo (JP); Masao AMANO, Uenohara-shi (JP); Kenichi INOUE, Tokyo (JP)

(73) Assignee: CASIO COMPUTER CO., LTD., Tokyo (JP)

(21) Appl. No.: 15/188,893

(22) Filed: Jun. 21, 2016

(30) Foreign Application Priority Data
Aug. 26, 2015 (JP) 2015-166529

(51) Int. Cl. G04B 19/12; G04C 10/02

(52) U.S. Cl. CPC G04B 19/12; G04C 10/02

(57) ABSTRACT

A dial includes a first deposited layer and a second deposited layer. The first deposited layer is disposed on an uneven surface and has no peak of spectral reflectance in a visible light range. The second deposited layer is on a flat surface and has a peak of spectral reflectance in the visible light range. The first deposited layer and the second deposited layer overlap with each other.

### CROSS REFERENCE TO RELATED APPLICATION

This application is based upon and claims the benefit of priority under 35 USC 119 of Japanese Patent Application No. 2015-166529 filed on Aug. 26, 2015, the entire disclosure of which, including the description, claims, drawings and abstract, is incorporated herein by reference in its entirety.

### BACKGROUND OF THE INVENTION

1. Field of the Invention

The present invention relates to a dial and a timepiece.

2. Description of Related Art

Traditional electronic devices, such as timepieces, equipped with solar panels receiving light to generate electric power are widely known (for example, refer to Japanese Unexamined Patent Application Publication No. 2014-173921). These electronic devices generate electric power with their solar panels and then charge the power in secondary batteries, and can thus operate for a long period without battery replacement.

In a typical electronic device equipped with a solar panel, for example, as is disclosed in Japanese Unexamined Patent Application Publication No. 2014-173921, the solar panel is disposed below a transmissive dial (on the rear side) so that the solar panel can receive light.

Unfortunately, a general solar panel has a deep-purple surface. The surface color of the solar panel disposed below the transmissive dial (on the rear side) is visible through the dial from the side (hereinafter referred to as “viewer side”) of the electronic device adjacent to a viewer. This feature impairs the design of the dial.

To address this problem, the dial can be made less transmissive to hide the surface color of the solar panel, or a reflective polarizing plate can be added between the dial and the solar panel to make the surface color of the solar panel less visible from the outside. Unfortunately, even in such configurations, the surface color of the solar panel can be recognized when viewed at certain angles. The complete hiding of the surface color is still a challenging problem.

In recent years, the electronic devices have been equipped with modules including many highly functional components, such as various sensors and/or various antennas capable of receiving time calibration signals, GPS signals, and/or radio waves for short-distance communication. This improvement leads to an increase in power consumption, resulting in a demand for preventing a decrease in the efficiency of power generation by the solar panels.

Unfortunately, the less transmissive dial and the reflective polarizing plate provide a reduction in the light to be received by the solar panel, thereby decreasing the efficiency of power generation. Such sacrifice of the efficiency of power generation by the solar panel is undesirable even for the purpose of improving the design of the dial.

In the electronic device, such as the timepiece, also required is the miniaturization of a case accommodating the dial and the solar panel. Unfortunately, the reflective polarizing plate between the dial and the solar panel requires a thicker case, and does not meet the requirement for the miniaturization.

### SUMMARY OF THE INVENTION

The present invention is a dial and a timepiece equipped with a solar panel and having an excellent design without sacrificing the efficiency of power generation by the solar panel, whose surface color is invisible from the outside.

One embodiment of the present invention includes a dial including a first deposited layer disposed on an uneven surface and having no peak of spectral reflectance in a visible light range; and a second deposited layer disposed on a flat surface and having a peak of spectral reflectance in the visible light range, wherein the first deposited layer and the second deposited layer overlap with each other.

### BRIEF DESCRIPTION OF THE DRAWINGS

FIG. 1 is a front view of a timepiece according to an embodiment;

FIG. 2 is a schematic cross-sectional view of main features of a dial and a solar panel;

FIG. 3 is a graph illustrating a spectral reflectance in a first deposited layer;

FIG. 4 is a graph illustrating a spectral reflectance in a second deposited layer;

FIGS. 5A to 5E are graphs each illustrating a spectral reflectance in a second deposited layer according to a modified embodiment;

FIG. 6 is a schematic cross-sectional view of main features of a dial and a solar panel according to a modified embodiment;

FIG. 7 is a schematic cross-sectional view of main features of a dial and a solar panel according to a modified embodiment;

FIG. 8 is a schematic cross-sectional view of main features of a dial and a solar panel according to a modified embodiment; and

FIG. 9 is a schematic cross-sectional view of main features of a dial and a solar panel according to a modified embodiment.

### DETAILED DESCRIPTION

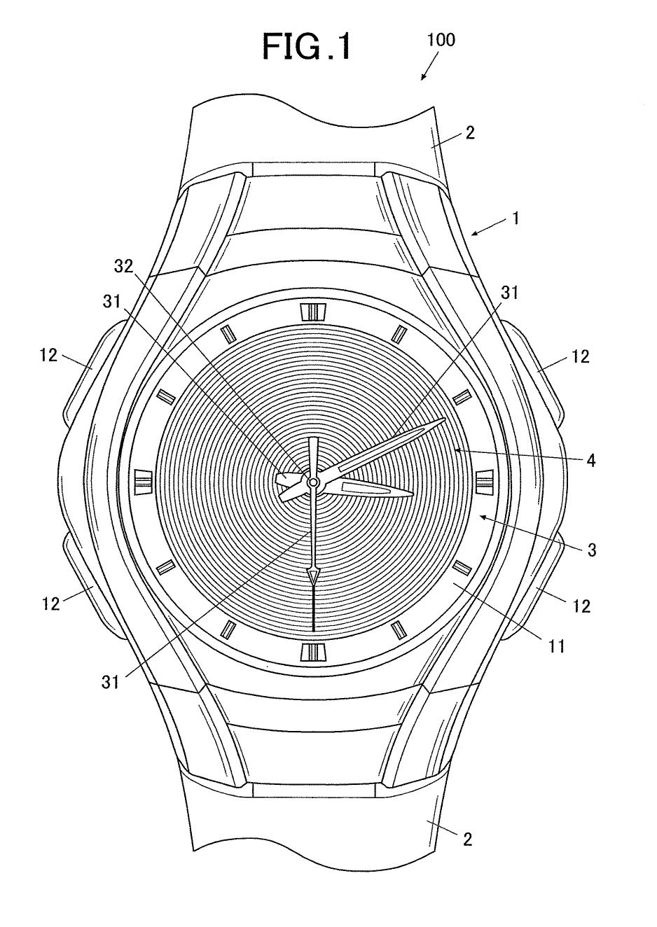

A dial and a timepiece according to an embodiment of the present invention will now be described with reference to FIGS. 1 to 4. Although the following description includes various limitations to describe technically preferred embodiments of the invention, the embodiments and the illustrated examples should not be construed to limit the invention.

FIG. 1 is a front view of a timepiece according to the present embodiment.

With reference to FIG. 1, a timepiece 100 according to the embodiment includes a case (hereinafter referred to as “timepiece case 1” in the embodiment) composed of, for example, a metal (e.g., stainless steel or titanium), ceramic, or any of various synthetic resins. The illustrated materials of the timepiece case 1 should not be construed to limit the invention.

The timepiece case 1 according to the embodiment has a short hollow cylindrical shape. The timepiece 100 is provided with a windshield 11 composed of a material, such as transparent glass, on the front side (the viewer side of the timepiece 100).

The timepiece 100 is also provided with a rear cover (not shown) on the rear side.

The timepiece case 1 is provided with timepiece bands 2 at the top and bottom ends in FIG. 1, that is, the ends at twelve and six o'clock of the timepiece 100.

The timepiece case 1 further includes operational buttons 12 along the circumference for inputting various operation instructions, such as an instruction for time calibration.

The timepiece case 1 accommodates a display unit including a dial 4 (described below).

As illustrated in FIG. 1, the display unit 3 according to the embodiment is of an analog system and includes hands 31 (i.e., a second hand, minute hand, and hour hand).

The timepiece case 1 also accommodates a timepiece movement (not shown) including, for example, a gear-train mechanism and a motor for driving the hands 31. The timepiece movement is provided with a hand shaft 32 extending therefrom. The hand shaft 32 penetrates near the center of the dial 4 and protrudes from the dial 4.

The hand shaft 32 consists of coaxially-disposed rotary axles for the hour hand, minute hand, and second hand. The hands 31 (e.g., the hour hand, minute hand, and second hand) are connected to the respective rotary axles around the hand shaft 32.

The timepiece movement drives the hand shaft 32 to rotate, so that the hands 31 connected to the respective rotary axles around the hand shaft 32 individually rotate on the front surface of the dial 4 around the hand shaft 32.

The illustrated features, such as the number of the hands 31 connected to the hand shaft 32 and rotating around the hand shaft 32, should not be construed to limit the invention. For example, the number of the hands 31 may be only one. Alternatively, the hands 31 may include any functional hand for display related to various functions, other than the hour hand, minute hand, and second hand. The functional hand may be supported by another hand shaft separate from the hand shaft 32 supporting the hour hand and the like.

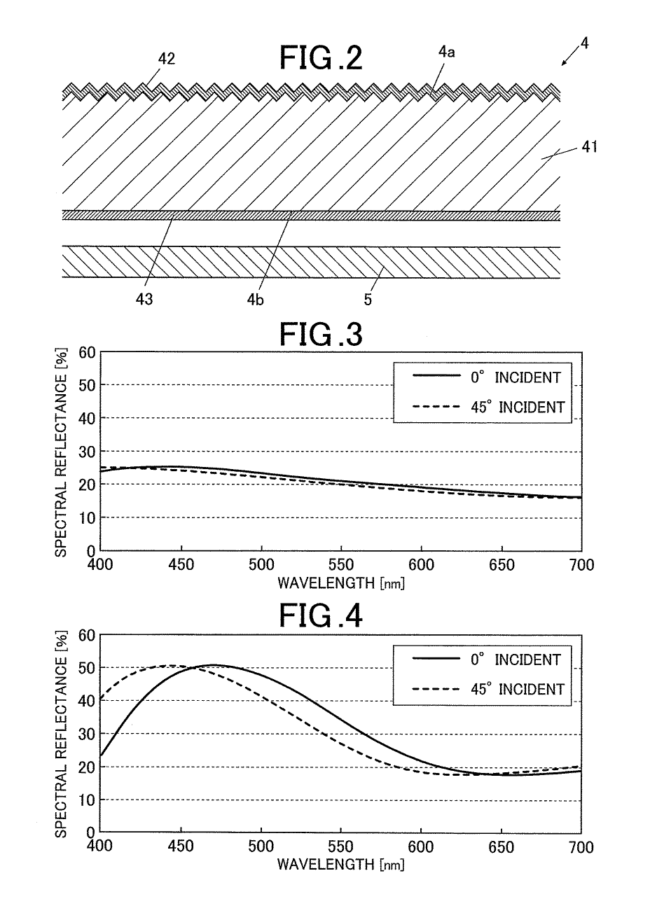

According to the embodiment, the timepiece case 1 also accommodates a solar panel 5 (refer to FIG. 2) behind the dial 4 (on the side of the timepiece 100 opposite to the viewer side).

The solar panel 5 receives light to generate electric power. The power generated by the solar panel 5 is charged in a secondary battery (not shown).

FIG. 2 is a schematic cross-sectional view of the dial and the solar panel disposed behind the dial according to the embodiment.

The dial 4 includes a transparent or translucent base plate 41 having an uneven surface 4a on one side and a flat surface 4b on the other side.

The base plate 41 is composed of, for example, a transparent or translucent resin or glass. It should be noted that the base plate 41 may be composed of any other material.

According to the embodiment, the uneven surface 4a of the base plate 41 faces the viewer side whereas the flat surface 4b of the base plate 41 faces the rear side (i.e., the side opposite to the viewer side), as illustrated in FIG. 2.

It should be noted that the flat surface 4b may be any surface that is substantially flat as a whole, other than a completely flat surface (smooth surface).

With reference to FIGS. 1 and 2, the uneven surface 4a has concentric circular serrations consisting of pointed protrusions and V grooves alternately disposed.

The protrusions and grooves define inclined segments of the uneven surface 4a that reflect light, so that the uneven surface 4a provides complex refraction and irregular reflection of light, like a prism.

The illustrated pattern of the uneven surface 4a should not be construed to limit the invention. For example, the unevenness may be formed not concentrically but spirally, or defined by radial grooves extending from the center to the circumference of the dial 4.

The uneven surface 4a of the base plate 41 is covered with a first deposited layer 42, which has no peak of spectral reflectance in the visible light range.

FIG. 3 is a graph illustrating a spectral reflectance in the first deposited layer 42 according to the embodiment.

In FIG. 3, the solid line indicates a spectral reflectance of 0° incident light in the first deposited layer 42, whereas the broken line indicates a spectral reflectance of 45° incident light in the first deposited layer 42.

As illustrated in FIG. 3, with respect to both incident light and 45° incident light, the spectral reflectance in the first deposited layer 42 gently varies around 20% regardless of the wavelength of the light, and has no peak at a certain wavelength in the visible light range.

That is, the first deposited layer 42 is a reflective film or a highly light-transmissive film having no certain color. The first deposited layer 42 is thus recognized as a film colored with silver or similar color when viewed from the outside.

The flat surface 4b of the base plate 41 is covered with a second deposited layer 43, which has a peak of spectral reflectance in the visible light range.

FIG. 4 is a graph illustrating a spectral reflectance in the second deposited layer 43 according to the embodiment.

In FIG. 4, the solid line indicates a spectral reflectance of 0° incident light in the second deposited layer 43, whereas the broken line indicates a spectral reflectance of 45° incident light in the second deposited layer 43.

As illustrated in FIG. 4, with respect to both 0° incident light and 45° incident light, the spectral reflectance in the second deposited layer 43 has a peak at a wavelength around 450 nm. That is, the second deposited layer 43 mainly reflects wavelength components of blue. The second deposited layer 43 is thus recognized as a film colored with blue or similar color when viewed from the outside.

In specific, the second deposited layer 43 on a flat surface, as in the embodiment, can appear in the exactly intended color.

According to the embodiment, the first deposited layer 42 and the second deposited layer 43 are each fabricated by laminating three compounds: an “oxide” (e.g., TiO₂, SiO₂, or ZrO₂), a “fluoride” (e.g., MgF₂ or CaF₂), and a “sulfide” (e.g., ZnS). Depending on circumstances, a pure metal, such as Ti or Cr, may be combined with these compounds.

It should be noted that the first deposited layer 42 and the second deposited layer 43 may be composed of any appropriate film-forming substance (deposition material) generally used for optical deposition.

The first deposited layer 42 and the second deposited layer 43 are each a laminate of, for example, several films to twenty films.

The illustrated configurations of the first deposited layer 42 and the second deposited layer 43 should not be construed to limit the invention. The number of layers may be one, or may be 100 or more.

The multilayer configurations of the first deposited layer 42 and the second deposited layer 43 may be each fabricated by, for example, alternately laminating two or three of the above-illustrated film-forming substances (deposition materials).

The first deposited layer 42 and the second deposited layer 43 each have a thickness of, for example, several to several hundred nanometers (several tens of to several thousand angstroms).

It should be noted that the multilayer configurations of the first deposited layer 42 and the second deposited layer 43 each preferably have a total thickness of 1 μm or smaller.

According to the embodiment, the base plate 41 has the uneven surface 4a and the flat surface 4b on both sides, and the first deposited layer 42 is disposed on the uneven surface 4a whereas the second deposited layer 43 is disposed on the flat surface 4b, as described above. The first deposited layer 42 and the second deposited layer 43 thus overlap with each other.

The first deposited layer 42 is disposed on the uneven surface 4a on the front of the base plate 41 and thus is more adjacent to the viewer side than the second deposited layer 43 is.

According to the embodiment, the dial 4, in which the first deposited layer 42 is disposed on the uneven surface 4a whereas the second deposited layer 43 is disposed on the flat surface 4b, is disposed more adjacent to the viewer side than the solar panel 5 accommodated in the timepiece case 1, as described above.

The operation of the dial 4 and the timepiece 100 including the dial 4 will now be explained according to the embodiment.

According to the embodiment, unevenness is formed on one surface of the transparent or translucent base plate 41. This surface serves as the uneven surface 4a whereas the other surface of the base plate 41 having no unevenness serves as the flat surface 4b. The first deposited layer 42, which has no peak of spectral reflectance in the visible light range, is formed through deposition onto the uneven surface 4a; while the second deposited layer 43, which has a peak of spectral reflectance in the visible light range, is formed through deposition onto the flat surface 4b. This process yields the dial 4.

As described above, the base plate 41 is provided with the first deposited layer 42 on one side and the second deposited layer 43 on the other side. The first deposited layer 42 and the second deposited layer 43 thus overlap with each other on both sides of the base plate 41 of the dial 4.

The dial 4 is then accommodated into the timepiece case such that the uneven surface 4a covered with the first deposited layer 42 faces the viewer side whereas the flat surface 4b covered with the second deposited layer 43 faces the rear side.

The solar panel 5 is then accommodated into the timepiece case 1 such that the solar panel 5 is disposed behind the dial 4 (on the rear side of the timepiece 100 opposite to the viewer side).

Thereafter, the timepiece movement and other components are further accommodated into the timepiece case 1, followed by fitting of the windshield 11 into the viewer-side opening of the timepiece case 1 and mounting of the rear cover onto the rear opening of the timepiece case 1.

The above process completes the timepiece 100.

As described above, the uneven surface 4a is disposed on one side of the dial 4 and is covered with the first deposited layer 42, which is a highly light-transmissive film having no peak of spectral reflectance in the visible light range. The complex refraction and reflection of light by the unevenness of the uneven surface 4a is combined with the reflection of light by the first deposited layer 42, thereby providing complex irregular reflection of light. Such irregular reflection makes the components below the first deposited layer 42 less visible, and can bring about a good visual effect, like the reflection of light by a prism.

In addition, the flat surface 4b is disposed on the other side of the dial 4 and is covered with the second deposited layer 43, which has a peak of spectral reflectance in the visible light range. This configuration makes the components below the dial 4 much less visible, and allows a color at a certain wavelength (in the embodiment, blue or similar color, as illustrated in FIG. 4) reflected by the second deposited layer 43 to be recognized through the dial 4 from the front side (i.e., viewer side). The dial 4 thus appears to have a glossy color.

This feature enables the dial 4, which is disposed more adjacent to the viewer side than the solar panel 5 is, to prevent the deep-purple surface color of the solar panel 5 from being recognized from the viewer side, although the solar panel 5 is disposed below the transmissive dial 4 (on the rear side). This configuration can ensure the design of the timepiece 100.

The thickness of each of the first deposited layer 42 and the second deposited layer 43 is as extremely thin as, for example, several to several hundred nanometers, as described above. The dial 4, which is provided with the first deposited layer 42 and the second deposited layer 43 and is disposed more adjacent to the viewer side than the solar panel 5 is, thus does not inhibit the reception of light by the solar panel 5, thereby ensuring the efficiency of power generation by the solar panel 5.

According to the embodiment, the dial 4 includes the first deposited layer 42 disposed on the uneven surface 4a and having no peak of spectral reflectance in the visible light range, and the second deposited layer 43 disposed on the flat surface 4b and having a peak of spectral reflectance in the visible light range, and the first deposited layer 42 and the second deposited layer 43 overlap with each other, as described above.

The complex refraction and reflection of light by the unevenness of the uneven surface 4a is combined with the reflection of light by the first deposited layer 42, thereby providing complex irregular reflection of light. This feature allows the dial 4 to have a luster and bring about a good visual effect.

The complex reflection of light by the unevenness of the uneven surface 4a and the first deposited layer 42 can also make the components below the dial 4 less visible.

In addition, the flat surface 4b is disposed on the other side of the dial 4 and is covered with the second deposited layer 43, which has a peak of spectral reflectance in the visible light range. This configuration makes the components below the dial 4 much less visible, and allows a color at a certain wavelength (in the embodiment, blue or similar color, as illustrated in FIG. 4) reflected by the second deposited layer 43 to be recognized through the dial 4 from the front side (i.e., viewer side). The dial 4 thus appears to have a glossy color. This feature can ensure the design of the dial 4.

According to the embodiment, the dial 4 includes the transparent or translucent base plate 41 having the uneven surface 4a and the flat surface 4b on both sides, which are covered with the first deposited layer 42 and the second deposited layer 43, respectively.

This configuration requires fewer components than a configuration further including sheets having the first deposited layer 42 and the second deposited layer 43, leading to a reduction in the thickness of the dial 4.

According to the embodiment, the first deposited layer 42 formed on the uneven surface 4a is disposed more adjacent to the viewer side than the second deposited layer 43 formed on the flat surface 4b is. The complex refraction and reflection of light by the unevenness of the uneven surface 4a is combined with the reflection of light by the first deposited layer 42, so that the surface of the dial 4 has a beautiful metallic luster when viewed from the viewer side.

According to the embodiment, the dial 4, which is disposed more adjacent to the viewer side than the solar panel 5 is, can effectively prevent the surface color of the solar panel 5 from being recognized through the dial 4 from the viewer side. While hiding the solar panel 5, the dial 4, which is the transparent or translucent base plate 41 covered with thin films on both sides, is sufficiently transmissive and does not inhibit the reception of light by the solar panel 5. The solar panel 5 thus has high efficiency of power generation, and can generate sufficient electric power to be consumed by the timepiece (electronic device) 100 equipped with many highly functional components, such as various antennas and sensors. This configuration can achieve compatibility between high design quality and high- and multi-functionality of the timepiece (electronic device) 100.

The above-described embodiments should not be construed to limit the invention and may be modified in various manners within the gist of the invention.

For example, although the second deposited layer 43 formed on the flat surface 4b mainly reflects wavelength components of blue or its vicinity in the embodiment, the second deposited layer 43 may have a peak of spectral reflectance at any wavelength in the visible light range other than the wavelength of blue or its vicinity.

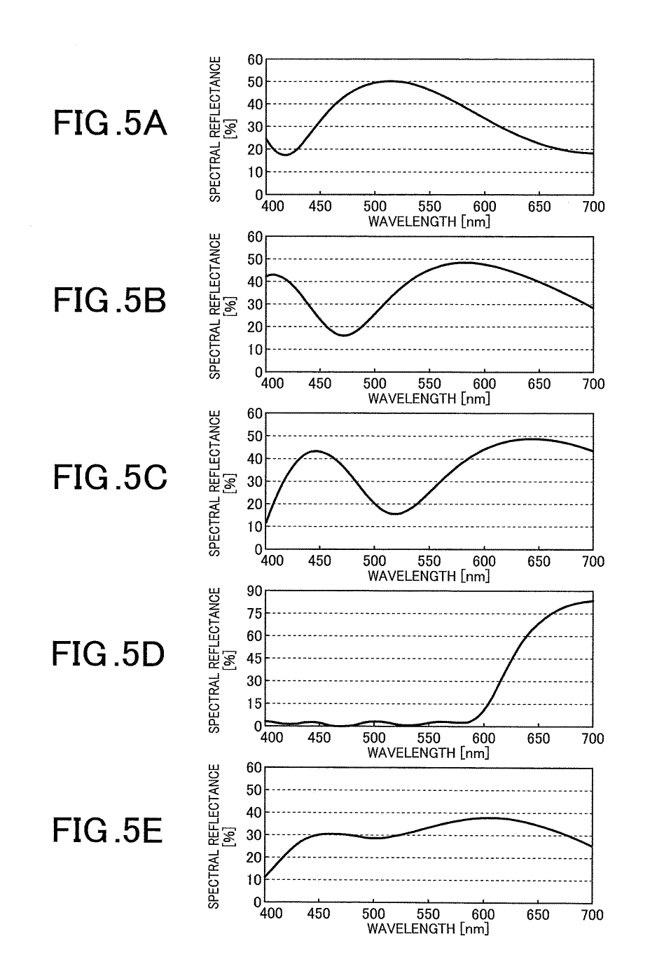

For example, with reference to FIG. 5A, the second deposited layer 43 may have a peak of spectral reflectance at a wavelength around 500 nm and mainly reflect wavelength components of green.

Alternatively, with reference to FIG. 5B, the second deposited layer 43 may have a peak of spectral reflectance at a wavelength around 600 nm and mainly reflect wavelength components of yellow.

Alternatively, with reference to FIG. 5C, the second deposited layer 43 may have peaks of spectral reflectance at a wavelength around 450 nm and a wavelength around 600 nm and mainly reflect wavelength components of pink.

Alternatively, with reference to FIG. 5D, the second deposited layer 43 may have a peak of spectral reflectance at a wavelength around 700 nm and mainly reflect wavelength components of red.

Alternatively, with reference to FIG. 5E, the second deposited layer 43 may have peaks of spectral reflectance at wavelengths from around 450 to around 600 nm and mainly reflect wavelength components of champagne.

That is, the second deposited layers 43 having peaks of spectral reflectance at different wavelengths in the visible light range can achieve various colors of the dials 4.

Although the uneven surface 4a has serrated unevenness in the embodiment, it may alternatively have any other uneven forms.

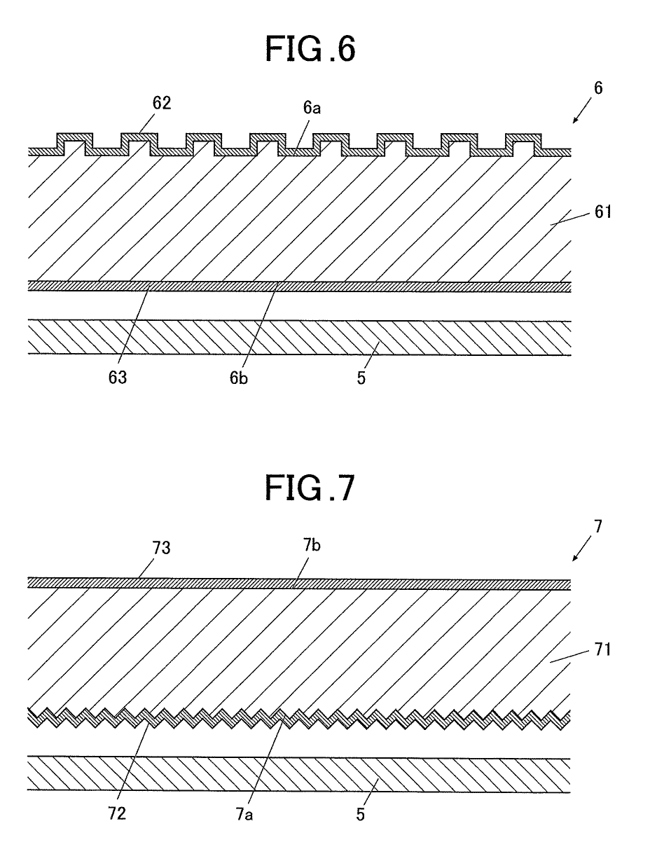

For example, with reference to FIG. 6, a base plate 61 of a dial 6 may be provided with an uneven surface 6a on the viewer side, of which protrusions are not pointed.

In this case, the base plate 61 is also provided with a flat surface 6b on the rear side, and the uneven surface 6a is covered with a first deposited layer 62 whereas the flat surface 6b is covered with a second deposited layer 63.

This configuration can also provide the visual effect through the irregular reflection of light by the uneven surface 6a and the first deposited layer 62 and through the overlapping of the first deposited layer 62 and the second deposited layer 63, and the effect of making the components below the dial 6 less visible.

Although the uneven surface 4a faces the viewer side of the dial 4 whereas the flat surface 4b faces the rear side in the embodiment, the positions of the uneven surface 4a and the flat surface 4b may be interchanged.

For example, with reference to FIG. 7, a base plate 71 of a dial 7 may be provided with an uneven surface 7a on the rear side and a flat surface 7b on the viewer side. In this case, the uneven surface 7a may be covered with a first deposited layer 72 whereas the flat surface 7b may be covered with a second deposited layer 73.

This configuration can also provide the visual effect through the overlapping of the first deposited layer 72 and the second deposited layer 73, and the effect of making the components below the dial 7 less visible.

Although the base plate 41 of the dial 4 is provided with the first deposited layer 42 and the second deposited layer 43 respectively on front and rear sides in the embodiment, the dial may have any other configuration.

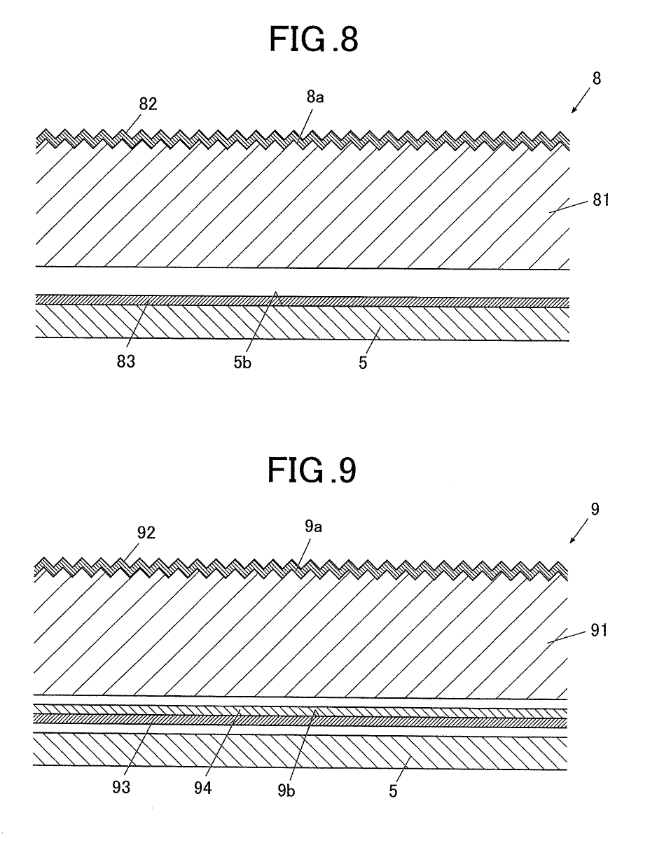

For example, with reference to FIG. 8, a base plate 81 of a dial 8 may be provided with an uneven surface 8a on one side to be covered with a first deposited layer 82, whereas the front surface of the solar panel 5 disposed below the base plate 81 (on the rear side) may serve as a flat surface 5b to be covered with a second deposited layer 83.

This configuration can also provide the visual effect through the overlapping of the first deposited layer 82 and the second deposited layer 83, and the effect of making the components below the dial 8 less visible.

In this case, the uneven surface 8a and the first deposited layer 82 formed thereon may alternatively be disposed on the rear side of the base plate 81.

The dial 4 may further include any component, other than the base plate 41, the first deposited layer 42, and the second deposited layer 43.

For example, with reference to FIG. 9, a dial 9 may include a sheet 94 disposed below a base plate 91 (on the rear side). In this case, the base plate 91 may be provided with an uneven surface 9a on one side to be covered with a first deposited layer 92, whereas one surface of the sheet 94 may serve as a flat surface 9b to be covered with a second deposited layer 93.

This configuration can also provide the visual effect through the irregular reflection of light by the uneven surface 9a and the first deposited layer 92 and through the overlapping of the first deposited layer 92 and the second deposited layer 93, and the effect of making the components below the dial 9 less visible.

In this case, the uneven surface 9a and the first deposited layer 92 formed thereon may alternatively be disposed on the rear side of the base plate 91.

Alternatively, the flat surface 9b and the second deposited layer 93 formed thereon may be disposed on the viewer side (front side) of the sheet 94.

Although the display unit 3, which includes the dial 4, is of an analog system and includes hands 31 in the embodiment, the display unit 3 may alternatively have any other configuration. For example, the dial may be of a combination of analog and digital systems and include a liquid-crystal panel.

Although the dial 4 is mounted on the timepiece 100 in the embodiment, the dial 4 may be mounted on any other electronic device.

For example, the dial according to the invention may be applied to a pedometer, heart rate meter, altimeter, or barometer.

The above-described embodiments should not be construed to limit the invention. The scope of the invention is defined by the following claims and equivalents thereof.

What is claimed is:

1. A dial comprising:
a first deposited layer disposed on an uneven surface and having no peak of spectral reflectance in a visible light range; and
a second deposited layer disposed on a flat surface and having a peak of spectral reflectance in the visible light range, wherein
the first deposited layer and the second deposited layer overlap with each other.

2. The dial according to claim 1, further comprising a transparent or translucent base plate having an uneven surface on one side and a flat surface on the other side, wherein
the first deposited layer is disposed on the uneven surface of the base plate, and
the second deposited layer is disposed on the flat surface of the base plate.

3. The dial according to claim 1, wherein the first deposited layer is disposed more adjacent to a viewer side than the second deposited layer is.

4. The dial according to claim 2, wherein the first deposited layer is disposed more adjacent to a viewer side than the second deposited layer is.

5. A timepiece comprising:
the dial according to claim 1; and
a case accommodating the dial.

6. A timepiece comprising:
the dial according to claim 2; and
a case accommodating the dial.

7. A timepiece comprising:
the dial according to claim 3; and
a case accommodating the dial.

8. A timepiece comprising:
the dial according to claim 4; and
a case accommodating the dial.

9. The timepiece according to claim 5, further comprising a solar panel accommodated in the case, wherein
the dial is disposed more adjacent to a viewer side than the solar panel is.

10. The timepiece according to claim 6, further comprising a solar panel accommodated in the case, wherein
the dial is disposed more adjacent to a viewer side than the solar panel is.

11. The timepiece according to claim 7, further comprising a solar panel accommodated in the case, wherein
the dial is disposed more adjacent to the viewer side than the solar panel is.

12. The timepiece according to claim 8, further comprising a solar panel accommodated in the case, wherein
the dial is disposed more adjacent to the viewer side than the solar panel is.
